(19) United States
(12) Patent Application Publication
(10) Pub. No.: US 2006/0215610 A1
(43) Pub. Date: Sep. 28, 2006

(54) In-vehicle mount type wireless communication device

(75) Inventor: Koji Shinoda, Chiryu-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/373,878

(22) Filed: Mar. 10, 2006

(30) Foreign Application Priority Data
Mar. 25, 2005 (JP) 2005-088547

(51) Int. Cl. H04Q 7/00

(52) U.S. Cl. 370/331; 370/335

(57) ABSTRACT

An in-vehicle mount type wireless communication device includes a wireless communication unit which can perform wireless communication in a first wireless communication system when within a first wireless communication area, and can perform wireless communication in the first wireless communication system and a second wireless communication system when the wireless communication device is located in a second wireless communication area. The device further includes a control unit for controlling the wireless communication unit to start wireless communication according to any one of the first wireless communication system and the second wireless communication system. The control unit controls the wireless communication unit to start the wireless communication according to the first wireless communication system if the wireless communication device is located in the second wireless communication area and a content of an application associated with wireless communication is a predetermined one.

### CROSS REFERENCE TO RELATED APPLICATIONS

This application is based on and incorporates herein by reference Japanese Patent Application No. 2005-88547 filed on Mar. 25, 2005, the contents of which are incorporated herein by reference.

### TECHNICAL FIELD

The technical field relates to an in-vehicle mount type wireless communication device that can perform wireless communication in a first wireless communication system when the wireless communication device concerned is located in a first wireless communication area for supplying the first wireless communication system conformable to a first wireless communication protocol, and can perform wireless communication in any one of the first wireless communication system and a second wireless communication system when the wireless communication device concerned is located in at least a second wireless communication area for supplying the first wireless communication system and a second wireless communication system conformable to a second wireless communication protocol which covers a smaller area than the first wireless communication protocol and has a higher communication speed.

### BACKGROUND

There is known an in-vehicle mount type wireless communication device in which a help notification signal is transmitted from a wireless communication circuit to a service center when a driver operates a help switch because the driver feels sick, for example (see Japanese Patent No. 3142263, for example).

There have been recently supplied plural wireless communication systems conformable to plural wireless communication protocols which are different from one another in coverage area (the number of areas per unit area) and communication speed, and in connection with this situation, there has been constructed a wireless communication system in which a first wireless communication area for supplying a first wireless communication system conformable to a first wireless communication protocol having a broad cover area and a low communication speed and a second wireless communication area for supplying two wireless communication systems of the first wireless communication system and a second wireless communication system conformable to a second wireless communication protocol having a narrow cover area and a high communication speed coexist.

According to the wireless communication system in which the first wireless communication area and the second wireless communication area coexist, the in-vehicle mount type wireless communication device necessarily starts wireless communication according to the first wireless communication area conformable to the first wireless communication protocol if the wireless communication device concerned is located in the first wireless communication area when a request for starting wireless communication occurs. However, it has been hitherto general that if the wireless communication device concerned is located in the second wireless communication area when the request for starting the wireless communication occurs, the wireless communication is started according to the second wireless communication system conformable to the second wireless communication protocol having a narrow cover area and a high communication speed on the basis of the background that greater importance is given to the communication speed.

In this communication style, however, when the in-vehicle mount type communication device is shifted from the second wireless communication area to the first wireless communication area, the hand-off from the second wireless communication protocol to the first wireless communication protocol is executed, that is, the hand-off is executed between different wireless communication protocols. Therefore, it is impossible to properly secure stable wireless communication.

Particularly, when the content of an application associated with wireless communication gives greater importance to the stability as in the case where a help notification signal is transmitted from a wireless communication circuit to a service center as described above, stable wireless communication is more strongly required as compared with normal voice call. Therefore, it has a significant effect that it is impossible to properly secure the stable wireless communication.

Furthermore, according to the in-vehicle mount type wireless communication device, if the wireless communication device concerned carries out wireless communication conformable with the first wireless communication system when the hand-off condition is established and also a shift destination area to which the wireless communication device concerned shifts is the second wireless communication area, it has been also hitherto general that the hand-off from the first wireless communication protocol to the second wireless communication protocol having a narrow coverage area and a high communication speed is executed on the basis of the background that greater importance is given to the communication speed, thereby switching the wireless communication system from the first wireless communication system to the second wireless communication system and continuing the wireless communication.

In the above operation, however, the in-vehicle wireless communication device also carries out the hand-off from the first wireless communication protocol to the second wireless communication protocol, that is, in this case, the hand-off between different wireless communication protocols is also executed, so that it is impossible to properly secure stable wireless communication.

### SUMMARY

In view of the above-described situation, it is an object to provide an in-vehicle wireless communication device that can avoid execution of the hand-off between different wireless communication protocols before it happens when the content of an application associated with wireless communication is a predetermined one, and thus properly secure stable wireless communication.

According to a first aspect, there is provided an in-vehicle mount type wireless communication device that comprises: a wireless communication unit which can perform wireless communication in a first wireless communication system when the wireless communication device concerned is located in a first wireless communication area for supplying the first wireless communication system conformable to a first wireless communication protocol, and can perform wireless communication in any one of the first wireless communication system and a second wireless communication system when the wireless communication device concerned is located in at least a second wireless communication area for supplying the first wireless communication system and a second wireless communication system conformable to a second wireless communication protocol which covers a smaller area than the first wireless communication protocol and has a higher communication speed; and a control unit for controlling the wireless communication unit to start wireless communication according to any one of the first wireless communication system and the second wireless communication system when a request for starting the wireless communication occurs, wherein when the request for starting the wireless communication occurs, the control unit controls the wireless communication unit to start the wireless communication according to the first wireless communication system if the wireless communication device concerned is located in the second wireless communication area and the content of an application associated with wireless communication is a predetermined one.

Accordingly, when the request for starting the wireless communication occurs, if the wireless communication device is located in the second wireless communication area and the content of an application associated with the wireless communication is a predetermined one, the wireless communication is not started according to the second wireless communication system conformable to the second wireless communication protocol, but started according to first wireless communication system conformable to the first wireless communication protocol. Accordingly, even when the wireless communication device subsequently shifts the communication area from the second wireless communication area to the first wireless communication area, the hand-off from the second wireless communication protocol to the first wireless communication protocol is not executed, but the hand-off from the first wireless communication protocol to the first wireless communication protocol is executed unlike the conventional wireless communication device. Accordingly, the hand-off between different wireless communication protocols can be avoided before it happens, and thus stable wireless communication can be properly secured.

According to a second aspect, there is provided an in-vehicle mount type wireless communication device that comprises: a wireless communication unit which can perform wireless communication in a first wireless communication system when the wireless communication device concerned is located in a first wireless communication area for supplying the first wireless communication system conformable to a first wireless communication protocol, and can perform wireless communication in any one of the first wireless communication system and a second wireless communication system when the wireless communication device concerned is located in at least a second wireless communication area for supplying the first wireless communication system and a second wireless communication system conformable to a second wireless communication protocol which covers a smaller area than the first wireless communication protocol and has a higher communication speed; and a control unit for controlling the wireless communication unit to execute the hand-off between wireless communication protocols and continue the wireless communication according to any one of the first wireless communication system and the second wireless communication system if a hand-off condition is established, wherein in the case where the control unit controls the wireless communication unit to execute the wireless communication according to the first wireless communication system and a shift destination area to which the wireless communication device concerned shifts is the second wireless communication area when the hand-off condition is established, the control unit controls the wireless communication unit to execute the hand-off from the first wireless communication protocol supplied from the wireless communication area before the area shift to the first wireless communication protocol supplied from the second wireless communication area after the area shift if the content of an application associated with the wireless communication is a predetermined one, whereby the wireless communication based on the first wireless communication system is continued with no change.

Accordingly, in the case where the control unit controls the wireless communication unit to execute the wireless communication according to the first wireless communication system and a shift destination area to which the wireless communication device concerned shifts is the second wireless communication area when the hand-off condition is established, when the content of the application associated with the wireless communication is a predetermined one, the hand-off from the first wireless communication protocol to the second wireless communication protocol is executed, and the hand-off from the first wireless communication protocol to the first wireless communication protocol is executed and thus the wireless communication based on the first wireless communication system is continued without switching the wireless communication system from the first wireless communication system to the second wireless communication system and continuing the wireless communication unlike the conventional wireless communication device. Accordingly, in this case, the hand-off between different wireless communication protocols can be avoided before it happens, and stable wireless communication can be properly secured.

### BRIEF DESCRIPTION OF THE DRAWINGS

FIG. 1 is a functional block diagram according to an embodiment;

FIG. 2 is a diagram showing a single area for supplying only a wireless communication system A and a hybrid area for supplying a wireless communication system B;

FIG. 3 is a flowchart showing the processing executed by CPU when an in-vehicle mount type wireless communication device is under an idling state;

FIG. 4 is a flowchart showing the processing executed by CPU when the in-vehicle mount type wireless communication device is under a packet communication state;

FIGS. 5A to 5D are diagrams showing hand-off; and

FIGS. 6A to 6D are diagrams corresponding to FIGS. 5A to 5D.

### DETAILED DESCRIPTION OF THE PREFERRED EMBODIMENTS

A preferred embodiment will be described hereunder with reference to the drawings. In this case, the following description will be made on the assumption that a wireless communication circuit 3 carries out packet communication.

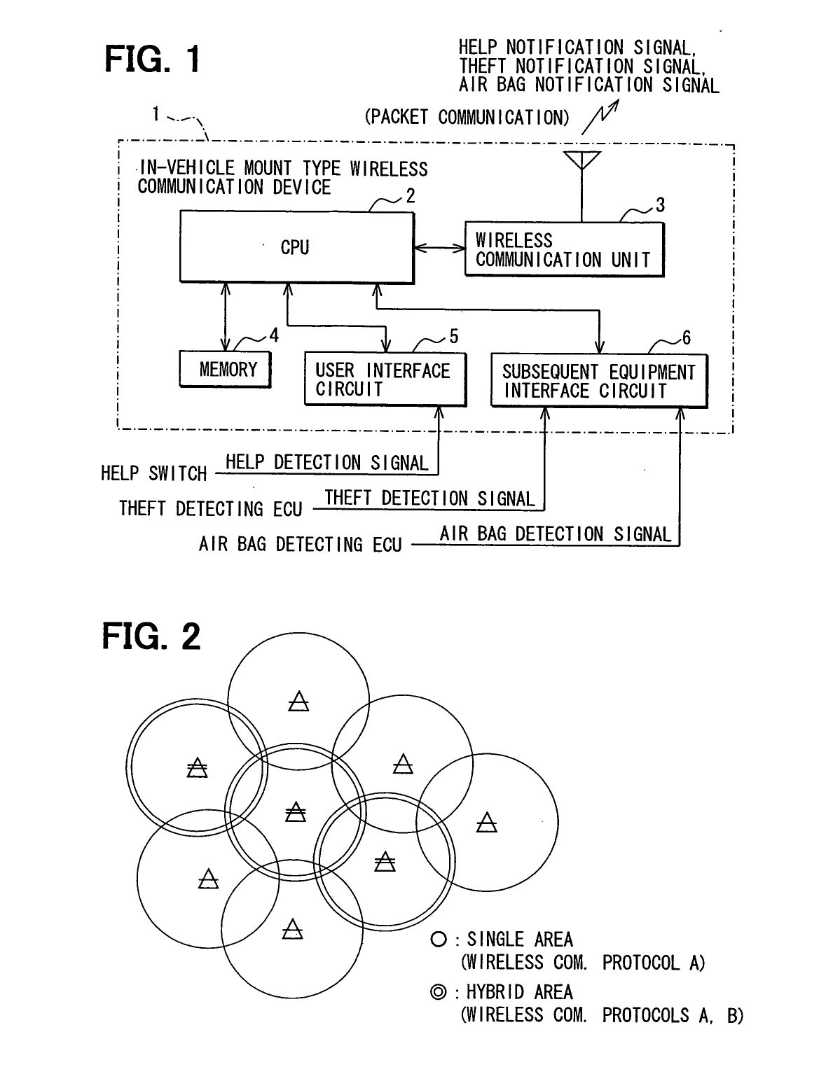

FIG. 1 is a functional block diagram showing the overall construction of the in-vehicle mount type wireless communication device 1. It comprises a CPU 2 (a control unit), a wireless communication circuit 3 (a wireless communication unit), a memory 4, a user interface circuit 5 and a subsequent equipment interface circuit 6.

The CPU 2 controls the all-around operation of the in-vehicle mount type wireless communication device 1 by executing a control program. The wireless communication circuit 3 carries out packet communication according to any one of a wireless communication system A (first wireless communication system) conformable to a wireless communication protocol A (first wireless communication protocol) having a broad cover area and a low communication speed and a wireless communication system B (second wireless communication system) conformable to a wireless communication protocol B (second wireless communication protocol) having a narrow cover area and a high communication speed.

The memory 4 stores various kinds of information such as information required to execute the control program by CPU 2, etc., for example. The user interface circuit 5 has a help switch and an interface function. The subsequent equipment interface circuit 6 has an interface function of interfacing to a theft detecting ECU and an air bag detecting ECU as subsequent equipment.

In the above-described construction, when a help detection signal indicating that a user operates the help switch is input from the help switch to the CPU 2 through the user interface circuit 5, CPU 2 transmits a help notification signal from the wireless communication circuit 3 to a server center. Furthermore, when a theft detection signal indicating that there is a risk of theft is input from the theft detecting EC through the subsequent equipment interface circuit 6, the CPU 2 controls the wireless communication circuit 3 to transmit the theft notification signal to the service center, or when an air bag detecting signal indicating that an air bag is expanded is input from the air bag detecting ECU through the subsequent equipment interface circuit 6, the CPU 2 controls the wireless communication circuit 3 to transmit an air bag notification signal to the service center. Furthermore, the subsequent equipment interface circuit 6 is also connected to other in-vehicle mount type equipment such as a navigation device, etc. in addition to the theft detecting ECU and the air bag detecting ECT.

FIG. 2 schematically shows a wireless communication area (first wireless communication area) for supplying only the wireless communication system A conformable to the wireless communication protocol A, and a wireless communication area (second wireless communication area) for supplying both the wireless communication system A conformable to the wireless communication protocol A and the wireless communication system B conformable to the wireless communication protocol B. In this embodiment, the wireless communication area for supplying only the wireless communication system A will be referred to as “single area”, and the wireless communication area for supplying both the wireless communication system A and the wireless communication system B will be referred to as “hybrid area”.

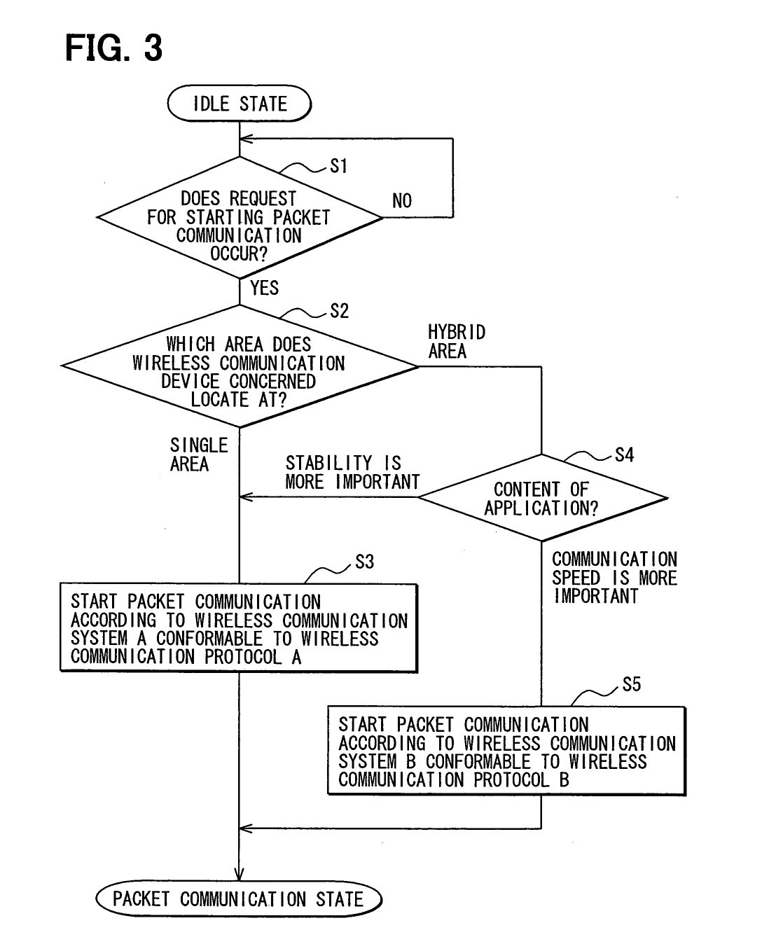

Next, the action of the above-described construction will be described with reference to FIGS. 3 to 6. In this case,

(1) a case where the in-vehicle mount type wireless communication device 1 is under idle state, and

(2) a case where the in-vehicle mount type wireless communication device 1 is under packet communication state, will be successively described.

(1) When the In-vehicle Mount Type Wireless Communication Device 1 is Under Idle State

First, the case where “the in-vehicle mount type communication device 1 is under idle state” will be described with reference to FIG. 3.

Under the state that the in-vehicle mount type wireless communication device 1 is under idle state, the CPU 2 judges whether a request for starting packet communication occurs (step S1). When detecting occurrence of the request for starting the packet communication (“Yes” in step S1), the CPU 2 judges whether the in-vehicle wireless communication device 1 is located in the single area or the hybrid area (step S2).

Here, when detecting that the in-vehicle mount type wireless communication device 1 is located in the single area, CPU 2 controls the wireless communication circuit 3 to start the packet communication according to the wireless communication system A conformable to the wireless communication protocol A because the single area is the area for supplying only the wireless communication wireless system A conformable to the wireless communication protocol A (step S3).

On the other hand, when detecting that the in-vehicle mount type wireless communication device 1 is located in the hybrid area, CPU 2 judges which one of the communication speed and the stability is considered as being more important with respect to the content of an application associated with the packet communication (step S4). In this embodiment, in accordance with the situation that the help detection signal is input from the help switch through the user interface circuit 5, the theft detection signal is input from the theft detecting ECU through the subsequent equipment interface circuit 6 or the air bag detection signal is input from the air bag detecting ECU through the subsequent equipment interface circuit 6, with respect to applications having high urgency which require the transmission of the help notification signal, the theft notification signal or the air bag notification signal from the wireless communication circuit 3 to the service center, it is judged that greater importance is given to the stability. On the other hand, with respect to applications having low urgency which requires transmission of personal information registered in a navigation device or the like to a user terminal or the like, it is judged that greater importance is given to the communication speed. CPU 2 executes the contents of these applications by identifying the transmission source of the detection signal or analyzing the detection signal.

When detecting that the content of the application associated with the wireless communication gives greater importance to the communication speed, CPU 2 selects the wireless communication system B having a narrow cover area and a high communication speed although the hybrid area is the area for supplying both the wireless communication system A conformable to the wireless communication protocol A and the wireless communication system B conformable to the wireless communication protocol B, and controls the wireless communication circuit 3 to start packet communication according to the wireless communication system B conformable to the wireless communication protocol B (step S5).

On the other hand, when detecting that the content of the application associated with the packet communication gives greater importance to the stability, CPU 2 selects the wireless communication system A having a low communication speed and a broad cover area unlike the case where the content of the application associated with the packet communication gives greater importance to the communication speed, and controls the wireless communication circuit 3 to start the packet communication according to the wireless communication system A conformable to the wireless communication protocol A (step S3).

Unlike the conventional in-vehicle mount type wireless communication device, through the series of processing described above, in the case where the in-vehicle mount type wireless communication device 1 is located in the hybrid area when the request for starting the packet communication occurs, the in-vehicle mount type wireless communication device starts the packet communication according to the wireless communication system A conformable to the wireless communication protocol A having a broad cover area without starting the packet communication according to the wireless communication system B conformable to the wireless communication protocol B having a high communication speed if the content of the application associated with the packet communication gives greater importance to the stability as in case where help notification signal, the theft notification signal or the air bag notification signal is transmitted from the wireless communication circuit 3 to the service center, for example.

(2) When the In-vehicle Mount Type Wireless Communication Device 1 is Under Packet Communication State

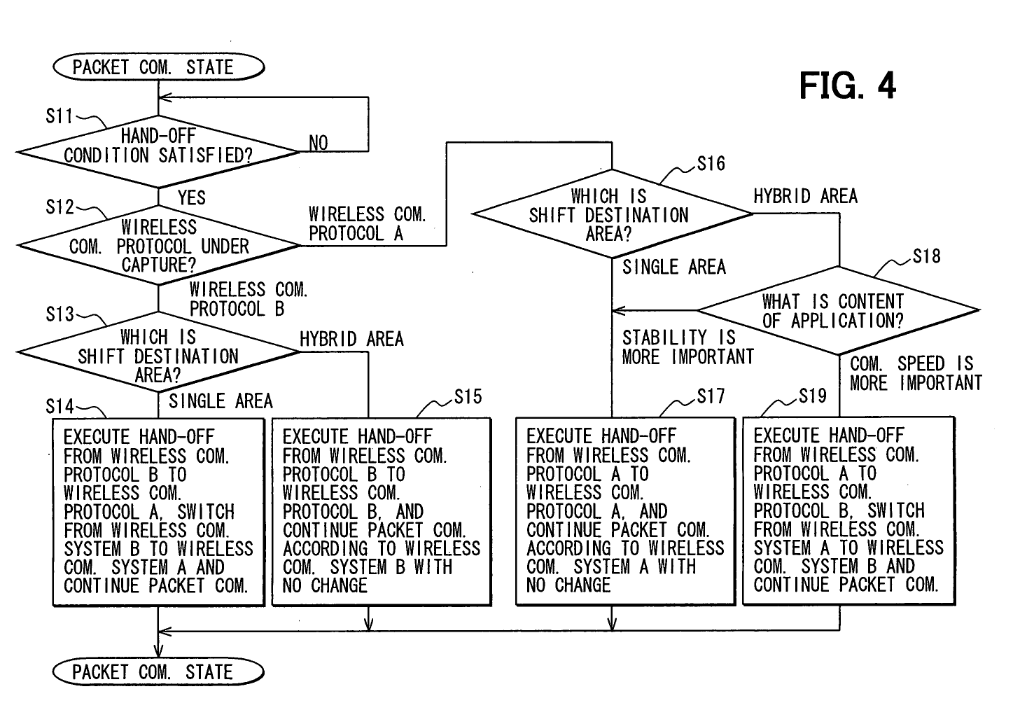

Next, the case where “the in-vehicle mount type wireless communication device 1 is under packet communication state” will be described with reference to FIGS. 4 to 6.

Under the state that the in-vehicle mount type wireless communication device 1 is under packet communication state, CPU 2 judges whether the hand-off condition is satisfied or not (step S1). In this case, CPU 2 judges the satisfaction or non-satisfaction of the hand-off condition by judging the reception electrical field intensities of received electrical waves from the base stations of plural areas in the district covering the plural areas. Then, when CPU 2 detects that the hand-off condition is satisfied (“YES” in step S11), it is identified which one of the wireless communication protocol A or the wireless communication protocol B the wireless communication protocol under capture is based on (step S12).

Here, CPU 2 detects that the in-vehicle mount type wireless communication 1 is located in the hybrid area and the wireless communication protocol under capture is the wireless communication protocol B, CPU 2 judges whether a shift destination area is a single area or hybrid area (step S1 3).

When detecting that the shift destination area is the single area, CPU 2 controls the wireless communication circuit 3 to execute the hand-off from the wireless communication protocol B supplied from the hybrid area before the area shift to the wireless communication protocol A supplied form the single area after the area shift, whereby the wireless communication system is switched from the wireless communication system B to the wireless communication system A and the packet communication is continued (step S14). Specifically, CPU 2 connects the communication link based on the wireless communication system A to the base station after the area shift, and disconnects the communication link based on the wireless communication system B from the base station before the area shift, whereby the wireless communication system is switched from the wireless communication system B to the wireless communication system A and the packet communication is continued.

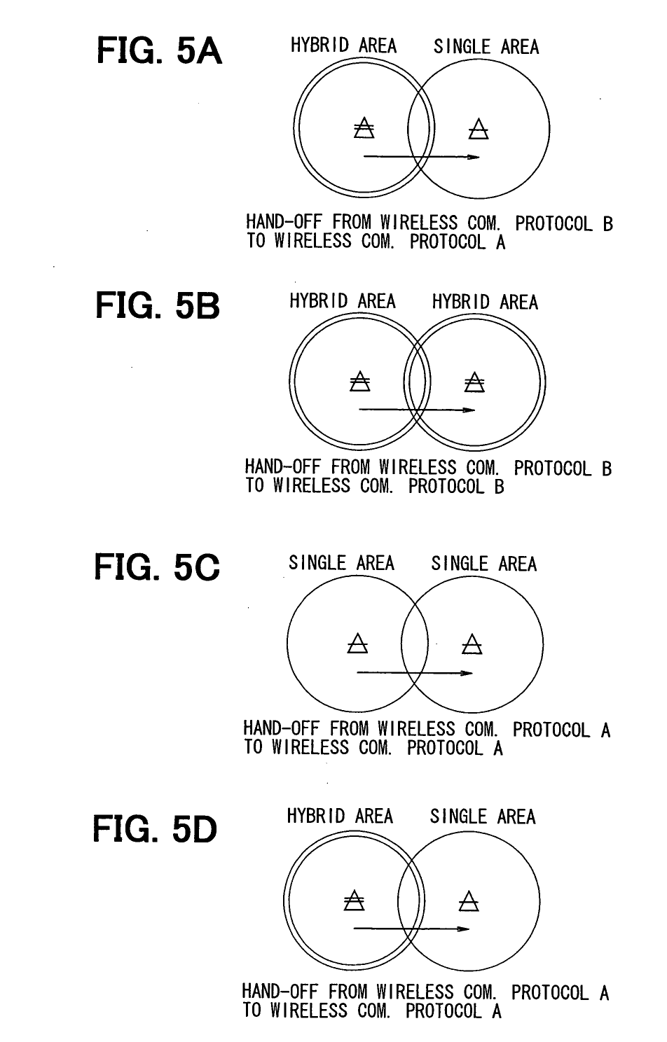

When detecting that the shift destination area is the hybrid area, on the basis of the background that greater importance is given to the communication speed, CPU 2 controls the wireless communication circuit 3 to execute the hand-off from the wireless communication protocol B supplied from the hybrid area before the area shift to the wireless communication protocol B supplied from the hybrid area after the area shift, and continues the packet communication based on the wireless communication system B with no change (step S15) as shown in FIG. 5B. Specifically, CPU 2 connects the communication link based on the wireless communication system B to the base station after the area shift, and disconnects the communication link based on the wireless communication system B from the base station before the area shift to continue the packet communication with no change.

On the other hand, when the CPU 2 detects that the wireless communication protocol under capture is the wireless communication protocol A, the CPU 2 also detects whether the shift destination area is the single area or hybrid area (step S16).

Then, when it is judged that the shift destination area is the single area, if the area before the area shift is the single area, the CPU 2 controls the wireless communication circuit 3 to execute the hand-off from the wireless communication protocol A supplied from the single area before the area shift to the wireless communication protocol A supplied from the single area after the area shift, and continues the packet communication based on the wireless communication system A with no change (step S17) as shown in FIG. 5C.

Furthermore, if the area before the shift is a hybrid area, as shown in FIG. 5D, CPU 2 controls the wireless communication circuit 3 to execute the hand-off from the wireless communication protocol A supplied from the hybrid area before the area shift to the wireless communication protocol A supplied from the single area after the area shift, and continues the packet communication based on the wireless communication system A with no change (step S17). Specifically, CPU 2 connects the communication link based on the wireless communication system A to the base station after the area shift, and disconnects the communication link based on the wireless communication system A from the base station before the area shift to continue the packet communication with no change.

On the other hand, when detecting that the shift destination area is the hybrid area, CPU 2 identifies which one of the communication speed and the stability the content of the application associated with the packet communication gives greater importance to (step S18).

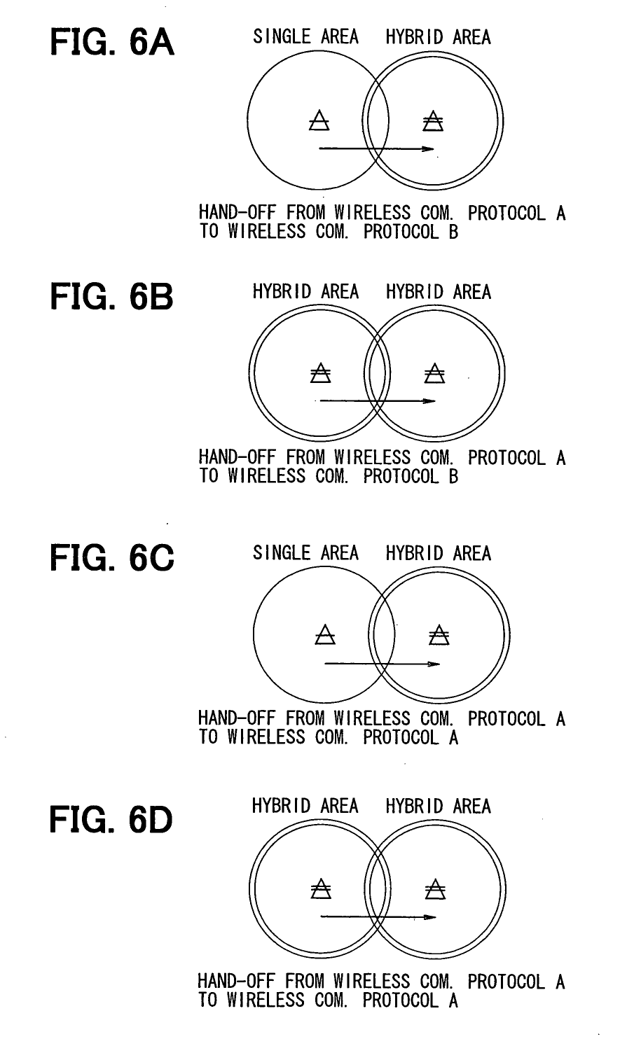

When detecting that the content of the application associated with the packet communication gives greater importance to the communication speed, CPU 2 selects the wireless communication system B having a narrow cover area, but a high communication speed although the hybrid area is the area for supplying the wireless communication system conformable to the wireless communication protocol A and the wireless communication system B conformable to the wireless communication protocol B. If the area before the shift is the single area, as shown in FIG. 6A, CPU 2 controls the wireless communication circuit 3 to execute the hand-off from the wireless communication protocol A supplied from the single area before the area shift to the wireless communication protocol B supplied from the hybrid area after the area shift, and switches the wireless communication system from the wireless communication system A to the wireless communication system B to continue the packet communication (step S19).

Furthermore, if the area before the shift is the hybrid area, as shown in FIG. 6B, CPU 2 controls the wireless communication circuit 3 to execute the hand-off from the wireless communication protocol A supplied from the hybrid area before the area shift to the wireless communication protocol B supplied from the hybrid area after the area shift, and switches the wireless communication system from the wireless communication system A to the wireless communication system B to continue the packet communication (step S19). Specifically, CPU 2 connects the communication link based on the wireless communication system B to the base station after the area shift, and disconnects the communication link based on the wireless communication system to the base station before the area shift, whereby the wireless communication system is switched from the wireless communication system A to the wireless communication system B to continue the packet communication.

On the other hand, when detecting that the content of the application associated with the packet communication gives greater importance to the stability, CPU 2 selects the wireless communication system A having a low communication speed, but a broad cover area, and if the area before the shift is the single area, CPU 2 controls the wireless communication circuit 3 to execute the hand-off from the wireless communication protocol A supplied from the single area before the area shift to the wireless communication protocol A supplied from the hybrid area after the area shift, and continues the packet communication based on the wireless communication system A with no change (step S17) as shown in FIG. 6C.

If the area before the shift is the hybrid area, the CPU 2 controls the wireless communication circuit 3 to execute the hand-off from the wireless communication protocol A supplied from the hybrid area before the area shift to the wireless communication protocol A supplied from the hybrid area after the area shift, and continues the packet communication based on the wireless communication system A with no change as shown in FIG. 6D (step S17). Specifically, CPU 2 connects the communication link based on the wireless communication system A to the base station after the area shift, and disconnects the communication link based on the wireless communication A to the base station before the area shift, whereby the packet communication based on the wireless communication system A is continued with no change.

Through the series of processing described above, in the in-vehicle mount type communication device 1, in the case where the wireless communication circuit 3 carries out the packet communication based on the wireless communication system A when the hand-off condition is satisfied and also the shift destination area to which the in-vehicle mount type wireless communication device concerned shifts is the hybrid area, if the content of the application associated with the packet communication gives greater importance to the stability as in the case where the help notification signal, the theft notification signal or the air back notification signal is transmitted from the wireless communication circuit 3 to the service center, the hand-off from the wireless communication protocol A to the wireless communication protocol having a broader cover area is executed, and the packet communication based on the wireless communication system A is continued with no change without executing the hand-off from the wireless communication protocol to the wireless communication protocol B having a higher communication speed, switching the wireless communication system from the wireless communication system A to the wireless communication system B and continuing the packet communication.

It is a general hand-off condition that a vehicle runs, that is, the in-vehicle mount type communication device 1 moves. However, even when a vehicle is under parking state or stop state, that is, the in-vehicle mount type communication device 1 does not move, the hand-off condition would be satisfied if the electric wave environment varies. Accordingly, in this case, the same processing as described is carried out. Accordingly not only the help notification signal can be surely transmitted to the service center by securing stable packet communication when a user feels sick during driving and thus operates the help switch, but also the theft notification signal or the air bag notification signal can be surely transmitted to the service center by securing stable packet communication even when the vehicle is under parking state or stop state and the theft detecting ECU detects that there is a risk of theft or the air bag detecting ECU detects that the air bag is expanded.

As described above, according to this embodiment, in the case where the in-mount type wireless communication device 1 is located in the hybrid area when the request for starting the packet communication occurs, if the content of the application associated with the packet communication gives greater importance to the stability as in the case where the help notification signal, the theft notification signal or the air bag notification signal is transmitted to the service center, the packet communication is not started according to the wireless communication system B conformable to the wireless communication protocol B having a higher communication speed, but the packet communication is started according to the wireless communication system A conformable to the wireless communication protocol A having a broader cover area. Therefore, even when the in-vehicle mount type wireless communication device subsequently shifts from the hybrid area to the single area, the hand-off is executed from the wireless communication protocol A to the wireless communication protocol A, that is, between the same wireless communication protocols unlike the conventional in-vehicle mount type wireless communication device. Therefore, the hand-off between different wireless communication protocols can be avoided before it happens, and stable packet communication can be properly secured.

Furthermore, in the case where the wireless communication circuit 3 carries out the packet communication according to the wireless communication system A when the hand-off condition is satisfied and also the shift destination area to which the in-vehicle mount type wireless communication device shifts is the hybrid area, if the content of the application associated with the packet communication gives greater importance to the stability as in the case where the help notification signal, the theft notification signal or the air bag notification signal is transmitted to the service center, the hand-off from the wireless communication protocol A to the wireless communication protocol A having a broad cover area, that is, the hand-off between the same wireless communication protocols is executed, and the packet communication based on the wireless communication system A is continued with no change without executing the hand-off from the wireless communication protocol A to the wireless communication protocol having a high communication speed, switching the wireless communication system from the wireless communication system A to the wireless communication system B and continuing the packet communication. Therefore, unlike the conventional in-mount type wireless communication device, the hand-off between different wireless communication protocols can be avoided from being executed before it happens, and thus stable packet communication can be properly secured.

The present invention is not limited to the above embodiment, and various modifications or expansions can be made without departing from the subject matter of the present invention.

The application giving greater importance to the stability is not limited to the case where the help notification signal, the theft notification signal or the air bag notification signal is transmitted from the wireless communication circuit to the service center, and it may be applied to other cases.

What is claimed is:

1. An in-vehicle mount type wireless communication device comprising:
a wireless communication unit which can perform wireless communication in a first wireless communication system when the wireless communication device is located in a first wireless communication area for supplying the first wireless communication system conformable to a first wireless communication protocol, and can perform wireless communication in any one of the first wireless communication system and a second wireless communication system when the wireless communication device concerned is located in at least a second wireless communication area for supplying the first wireless communication system and a second wireless communication system conformable to a second wireless communication protocol which covers a smaller area than the first wireless communication protocol and has a higher communication speed; and
a control unit for controlling the wireless communication unit to start wireless communication according to any one of the first wireless communication system and the second wireless communication system when a request for starting the wireless communication occurs, wherein when the request for starting the wireless communication occurs, the control unit controls the wireless communication unit to start the wireless communication according to the first wireless communication system if the wireless communication device is located in the second wireless communication area and a content of an application associated with wireless communication is a predetermined one.

2. An in-vehicle mount type wireless communication device comprising:
a wireless communication unit which can perform wireless communication in a first wireless communication system when the wireless communication device is located in a first wireless communication area for supplying the first wireless communication system conformable to a first wireless communication protocol, and can perform wireless communication in any one of the first wireless communication system and a second wireless communication system when the wireless communication device is located in at least a second wireless communication area for supplying the first wireless communication system and a second wireless communication system conformable to a second wireless communication protocol which covers a smaller area than the first wireless communication protocol and has a higher communication speed; and
a control unit for controlling the wireless communication unit to execute the hand-off between wireless communication protocols and continue the wireless communication according to any one of the first wireless communication system and the second wireless communication system if a hand-off condition is established, wherein in the case where the control unit controls the wireless communication unit to execute the wireless communication according to the first wireless communication system and a shift destination area to which the wireless communication device shifts is the second wireless communication area when the hand-off condition is established, the control unit controls the wireless communication unit to execute the hand-off from the first wireless communication protocol supplied from the wireless communication area before the area shift to the first wireless communication protocol supplied from the second wireless communication area after the area shift if a content of an application associated with the wireless communication is a predetermined one, whereby the wireless communication based on the first wireless communication system is continued with no change.
